(19) United States
(12) Patent Application Publication
(10) Pub. No.: US 2024/0009928 A1
(43) Pub. Date: Jan. 11, 2024

(54) METHODS FOR MANUFACTURING CUSTOM ORTHOTIC SANDAL

(71) Applicant: Benjamin K. Watson, South Ogden, UT (US)

(72) Inventor: Benjamin K. Watson, South Ogden, UT (US)

(21) Appl. No.: 17/811,826

(22) Filed: Jul. 11, 2022

(51) Int. Cl. B29C 64/386; B33Y 10/00; B33Y 50/00; B33Y 40/20; B29C 64/118; B29D 35/14

(52) U.S. Cl. CPC B29C 64/386; B33Y 10/00; B33Y 50/00; B33Y 40/20; B29C 64/118; B29D 35/142

(57) ABSTRACT

Methods, systems, and devices for manufacturing a custom orthotic sandal. The described techniques may include generating a footbed model for a subject's foot based at least in part on a foot model. The foot model may be obtained by scanning the foot of the subject. One or more transforms may be applied to the footbed model. The one or more transforms may include expanding the footbed model along one or more bisection lines. The modified footbed model may extruded in at least one dimension to obtain a midsole model. A sandal midsole may be manufactured out of a material according to the midsole model. The sandal midsole may be used in the custom orthotic sandal.

### BACKGROUND

Orthotic insoles are used in shoes to provide additional support for people who have various conditions such as low arches, high arches, heel spurs, foot deformities, plantar fasciitis, lateral foot instability, foot or back pain, or to generally reduce pressure points for additional comfort or performance. However, orthotic insoles generally cannot be used with open-style shoes such as sandals because open-style shoes lack the shoe sidewalls that keep the orthotic in place.

### SUMMARY

The described techniques relate to improved methods, systems, devices, and apparatuses that support methods for manufacturing custom orthotic sandals. For example, the described techniques provide for generating a footbed model for a custom orthotic sandal for a subject's foot based at least in part on a foot model (e.g., a representation of a portion of the foot). The foot model may be obtained by scanning the foot of the subject. One or more transforms may be applied to the footbed model. A midsole model may be obtained by extruding the modified footbed model in at least one dimension. A sandal midsole may be manufactured out of a material according to the midsole model. The sandal midsole may be used in the custom orthotic sandal.

### BRIEF DESCRIPTION OF THE DRAWINGS

FIG. 1 shows examples of models that support methods for manufacturing custom orthotic sandals in accordance with examples described herein.

FIG. 2 shows examples of models that support methods for manufacturing custom orthotic sandals in accordance with examples described herein.

FIG. 3 shows examples of models that support methods for manufacturing custom orthotic sandals in accordance with examples described herein.

FIGS. 4A and 4B show examples of transforms for a footbed model that support methods for manufacturing custom orthotic sandals in accordance with examples described herein.

FIG. 5A shows an example of a midsole model that supports methods for manufacturing custom orthotic sandals in accordance with examples described herein.

FIG. 5B shows an example of a sandal perimeter model that supports methods for manufacturing custom orthotic sandals in accordance with examples described herein.

FIGS. 6A-6C show examples of a midsole model that supports methods for manufacturing custom orthotic sandals in accordance with examples described herein.

FIG. 7 shows an example of a sandal midsole that supports methods for manufacturing custom orthotic sandals in accordance with examples described herein.

FIG. 8 shows an example of a sandal that supports methods for manufacturing custom orthotic sandals in accordance with examples described herein.

FIG. 9 illustrates an example of a system that supports methods for manufacturing custom orthotic sandals in accordance with examples described herein.

FIG. 10 illustrates an example of a system that supports methods for manufacturing custom orthotic sandals in accordance with examples described herein.

FIG. 11 illustrates an example of a method for manufacturing custom orthotic sandals in accordance with examples described herein.

### DETAILED DESCRIPTION

Orthotic insoles are used to decrease or eliminate foot pain, or to increase performance. However, orthotic insoles generally cannot be used with open-style shoes such as sandals because open-style shoes lack the shoe sidewalls that keep the orthotic in place.

The described techniques enable the creation of orthotic open-style shoes such as sandals that conform to the feet and provide the benefit of orthotics with the style and airflow of a sandal. The described techniques include scanning a subject's feet to form a footbed model, applying one or more transforms to the footbed model, extruding the footbed model to obtain a midsole model, and manufacturing a midsole from the three midsole model. The transforms may be applied to provide room for the foot in the orthotic footbed of the sandal while maintaining the orthotic alignment of key footbed features with structural elements of the foot. The manufacturing may be performed using 3D printing, which may allow a fully custom midsole for a sandal to be obtained. A cushioning layer may be added above the midsole for comfort, and a sole material may be added below the midsole for additional traction and durability.

Aspects of the disclosure are initially described in the context of models that relate to methods for manufacturing custom orthotic sandal. Aspects of the disclosure are further illustrated by and described with reference to apparatus diagrams, system diagrams, and flowcharts that relate to methods for manufacturing custom orthotic sandal.

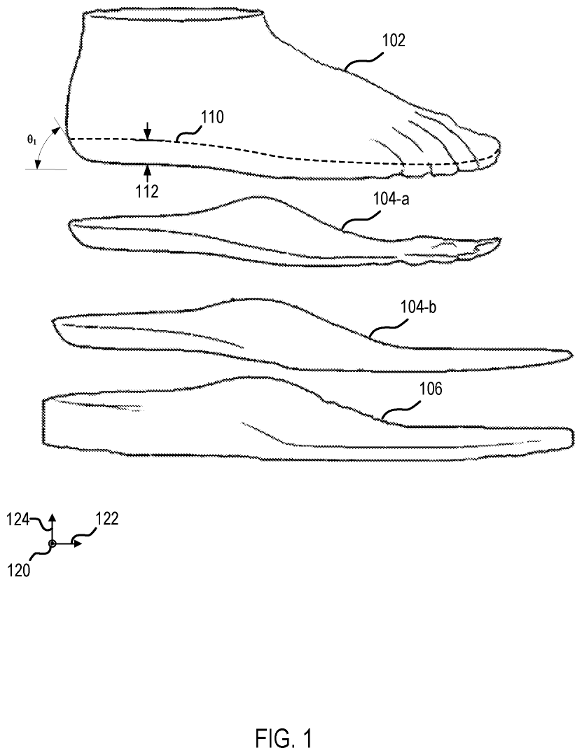

FIG. 1 shows examples of models that support methods for manufacturing custom orthotic sandal in accordance with examples described herein. FIG. 1 shows a foot model 102 that may be obtained by scanning a subject's foot. For example, a 3-dimensional (3D) scanner may be used that generates a 3D model of the foot using laser scanning or other scanning techniques.

A footbed model 104-a may be generated from the foot model 102 by applying a section line 110 to the foot model 102. For example, the section line 110 may be determined along the outer perimeter of the foot model 102 according to one or more dimensions 112, such as dimensions at a heel area or dimensions at a toe area. The section line 110 may also have an increased height (e.g., along a z-axis 124) at a medial arch area of the foot (not shown), for arch support. In some cases, at least portions of the section line 110 may be defined by an angle θ1 between a tangent line to the shape of the foot model 102 and a horizontal plane (e.g., a plane defined by an x-axis 120 and a y-axis 122). The angle θ1 may be, for example, 45 degrees, 50 degrees, 55 degrees, 60 degrees, or some other angle. In some cases, the section line 110 is defined by one or more dimensions 112 in combination with one or more angles applied in various portions of the foot model 102.

Once the footbed model 104-a is obtained, one or more transforms may be applied to the footbed model 104-a to obtain a modified footbed model 104-b. The transforms may include scaling at least a portion of the footbed model 104-a, expanding the footbed model 104-a along one or more bisection lines, or other transforms.

The modified footbed model 104-b may then be extruded along one or more dimensions (e.g., along a negative z-axis 124) to obtain a midsole model 106. The midsole model 106 may then be trimmed in various ways to obtain a final midsole model (not shown) that may be manufactured (e.g., using 3D printing) to obtain a sandal midsole (not shown). For example, the midsole model 106 may be trimmed according to a sandal perimeter model (not shown) to match a general shape of the perimeter of the foot model 102 (e.g., with perimeter extension area). Additionally or alternatively, the midsole model 106 may be trimmed according to a rocker profile (e.g., forefoot or heel rocker profile) or an arch profile. In addition, one or more channels may be subtracted from the midsole model 106 prior to manufacturing the sandal midsole. Once the sandal midsole is manufactured, one or more additional operations may be performed to complete the custom orthotic sandal. For example, a sole may be attached to an underside of the sandal midsole, a cushioning layer (e.g., foam) may be attached to a top side of the sandal midsole, or straps may be added, passing through the one or more channels for securing the sandal to the wearer's foot.

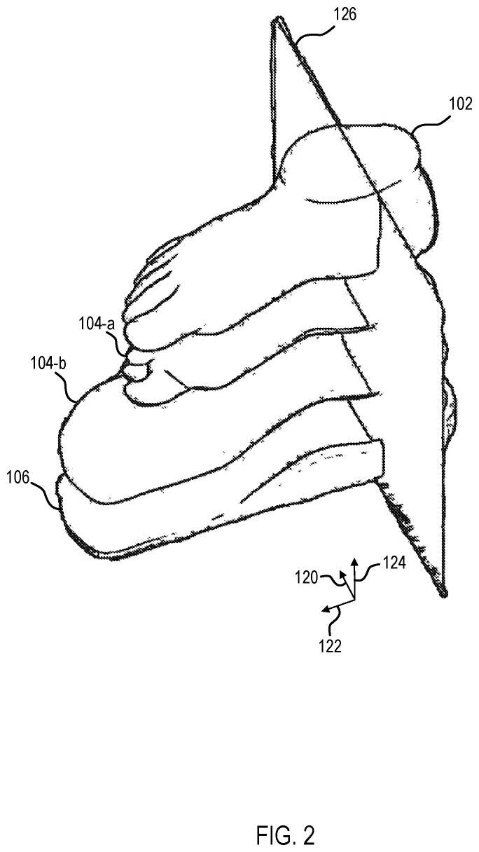

FIG. 2 show examples of models that support methods for manufacturing custom orthotic sandals in accordance with examples described herein. FIG. 2 illustrates foot model 102, footbed model 104-a, modified footbed model 104-b, and midsole model 106 from a first oblique angle. FIG. 2 illustrates a frontal plane 126. Frontal plane 126 may be shown as positioned along a weight bearing portion of a calcaneus of the foot (e.g., of foot model 102).

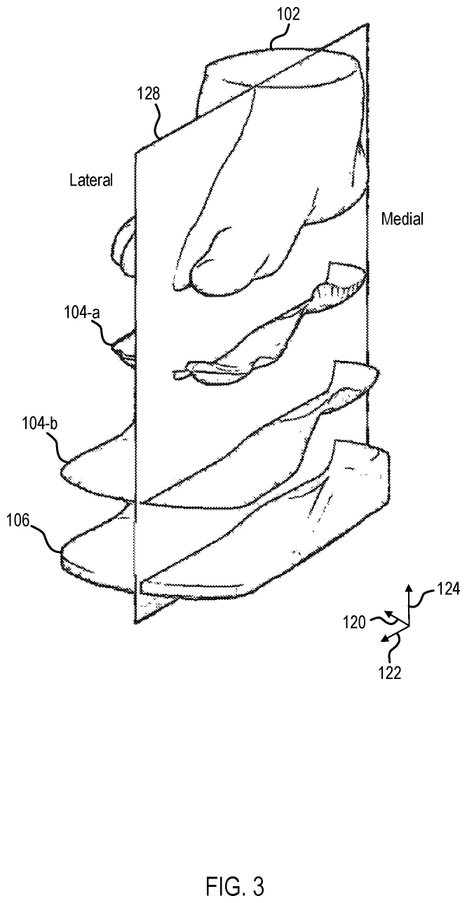

FIG. 3 shows examples of models that support methods for manufacturing custom orthotic sandals in accordance with examples described herein. FIG. 3 illustrates foot model 102, footbed model 104-a, modified footbed model 104-b, and midsole model 106 from a second oblique angle. FIG. 3 illustrates a central longitudinal plane 128 that divides the illustrated models into medial and lateral regions.

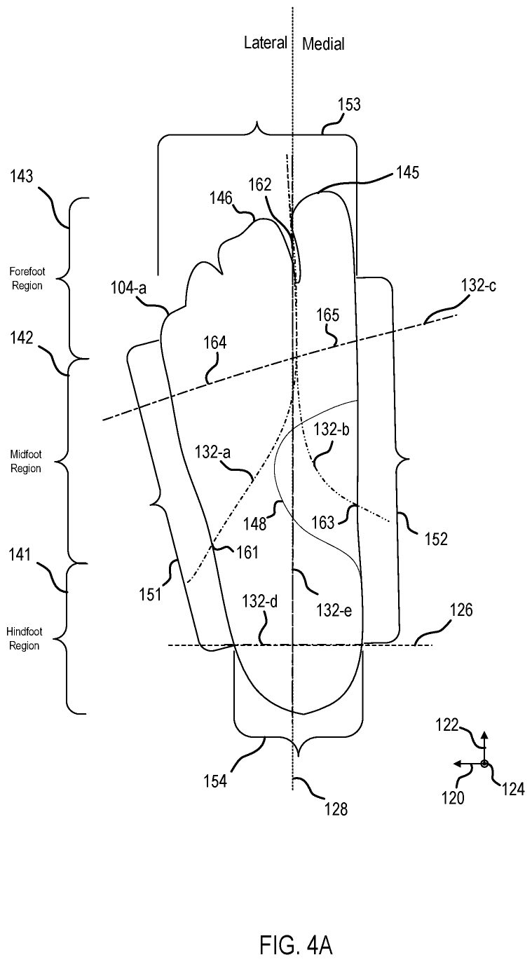

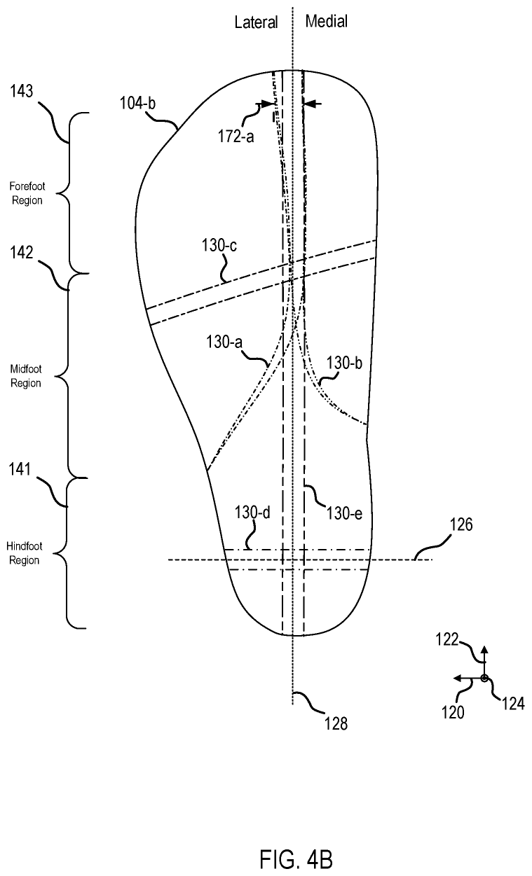

FIGS. 4A and 4B show examples of transforms for a footbed model 104 that support methods for manufacturing custom orthotic sandals in accordance with examples described herein. FIGS. 4A and 4B illustrate example bisection lines 132 for transforms 130 that may be applied to footbed model 104-a to result in a modified footbed model 104-b. Each of the transforms 130 may be based on a bisection line 132. In some cases, one or more of the bisection lines may intersect with each other. Frontal plane 126 is shown in a heel region of the footbed model. In some cases frontal plane 126 bisects the weight bearing portion of the calcaneus of the foot. In some cases, the weight bearing portion of a calcaneus of the foot may be determined based on characteristics of the footbed model 104 such as depth (e.g., along z-axis 124) of the footbed model 104 in a hindfoot region of the footbed model 104. Also shown in FIGS. 4A and 4B is central longitudinal plane 128 (e.g., sagittal plane), which may divide the footbed model 104 into lateral and medial sides.

In some cases, one or more of the bisection lines may intersect with a lateral edge 151, a medial edge 152, a front edge 153, or a hind edge 154. The lateral edge 151 may generally be defined as the edge of the footbed model 104 on the lateral side of the central longitudinal plane 128 and extending from frontal plane 126 (e.g., positioned along a weight bearing portion of a calcaneus of the foot) to a base of the fifth toe (little toe). The medial edge 152 may generally be defined as the edge of the footbed model 104 on the medial side of the central longitudinal plane 128 and extending from frontal plane 126 to a base of the first toe 145 (big toe). The front edge 153 may generally be defined as the edge of the footbed model 104 at the toe region (e.g., in between the lateral edge 151 and the medial edge 152). The hind edge 154 may generally be defined as the edge of the footbed model 104 at the heel region (e.g., in between the lateral edge 151 and the medial edge 152).

In some cases, one or more of the bisection lines may be in a hindfoot region 141, a midfoot region 142, or a forefoot region 143 of the footbed model 104, or may cross more than one region. The hindfoot region 141 may generally be defined by the calcaneus and talus bones of the foot, the midfoot region 142 may generally be defined by the navicular, cuboid, and cuneiform bones of the foot, and the forefoot region 143 may generally be defined by the front portions of the foot including the metatarsal bones and phalanx bones. In some cases, the regions of the footbed model 104 may be determined based on characteristics of the footbed model 104 such as overall length and width of the footbed model 104, and location of an arch region 148 of the footbed model 104.

A first bisection line 132-a may intersect with a first point 161 on the lateral edge 151 and a second point 162 on the front edge 153. The first point 161 may correspond to a base of the fifth metatarsal of the foot. The second point 162 may correspond to an interspace between the first toe 145 (big toe) and the second toe 146 of the foot (e.g., where the second toe is adjacent to the first toe). In some cases, the first bisection line 132-a may have an arc profile that may be defined by a polynomial function that is determined based on characteristics of the morphology of the footbed model 104 such as a length of the footbed model 104, a width of the footbed model 104, a distance between the first point 161 and the second point 162, or a combination of these characteristics.

A second bisection line 132-b may intersect with a third point 163 on the medial edge 152 and the second point 162 on the front edge 153. The third point 163 may correspond to the apex of the arch of the foot. In some cases, the second bisection line 132-b may have an arc profile that may be defined by a polynomial function that is determined based characteristics of the morphology of the footbed model 104 such as a length of the footbed model 104, a width of the footbed model 104, a distance between the third point 163 and the second point 162, or a combination of these characteristics.

A third bisection line 132-c may intersect with a fourth point 164 on the medial side of the footbed model and a fifth point 165 on the lateral side of the footbed model 104. In some cases, the fourth point 164 and the fifth point 165 are associated with the metatarsophalangeal joints. Thus, in these examples the third bisection line 132-c bisects the footbed model 104 along the metatarsophalangeal joints. In some cases, the third bisection line 132-c may have an arc profile that may be defined by a polynomial function that is determined based on characteristics of the morphology of the footbed model 104 such as a length of the footbed model 104, a width of the footbed model 104, a position of the fourth point 164 (e.g., a lateral side of the metatarsophalangeal joints), a position of the fifth point 165 (e.g., a medial side of the metatarsophalangeal joints), or a combination of these characteristics.

A fourth bisection line 132-d may bisect the footbed model 104 along the frontal plane 126. The fourth bisection line 132-d may be a straight line or may have an arc profile that may be defined by a polynomial function that is determined based characteristics of the morphology of the footbed model 104 such as a length of the footbed model 104, a width of the footbed model 104, or a combination of these characteristics.

A fifth bisection line 132-e may bisect the footbed model 104 along the central longitudinal plane 128. The fifth bisection line 132-e may be a straight line or may have an arc profile that may be defined by a polynomial function that is determined based characteristics of the morphology of the footbed model 104 such as a length of the footbed model 104, a width of the footbed model 104, or a combination of these characteristics.

In some examples, other bisection lines may be used as alternatives or in addition to one or more of bisection lines 132-a, 132-b, 132-c, 132-d, and 132-e. For example, although the illustrated bisection lines 132 are straight or are curves without inflection points, more complex bisection lines may be used such as bisection lines that have inflection points.

FIG. 4B illustrates the modified footbed model 104-b after having transforms 130 applied by expanding the footbed along bisection lines 132. For example, transform 130-a illustrates expanding the footbed along bisection line 132-a, transform 130-b illustrates expanding the footbed along bisection line 132-b, transform 130-c illustrates expanding the footbed along bisection line 132-c, transform 130-d illustrates expanding the footbed along bisection line 132-d, transform 130-e illustrates expanding the footbed along bisection line 132-e.

In some cases, an amount of expansion for one or more of the transforms 130 may vary along the corresponding bisection line 132. For example, for transform 130-a, the footbed model 104-b may not be expanded at a start point of bisection line 132-a (e.g., first point 161), and the amount of expansion 172-a may increase towards an end point of bisection line 132-a (e.g., second point 162). The change in the amount of expansion along the bisection line 132 of a transform 130 may be linear, or be non-linear. The change in the amount of expansion may be determined according to a function (e.g., linear function, polynomial function) based on the characteristics of the morphology of the footbed model 104.

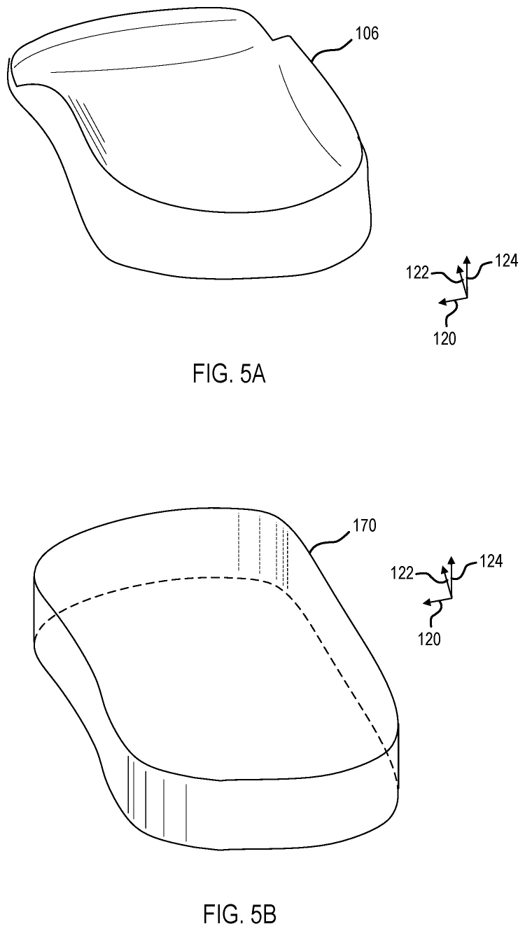

FIG. 5A shows an example of a midsole model 106 that supports methods for manufacturing custom orthotic sandals in accordance with examples described herein. The modified footbed model 104-b obtained from applying the transforms to the footbed model 104-a may be extruded to obtain the midsole model 106. For example, the modified footbed model 104-b may be extruded along a dimension (e.g., negative z-axis 124), and trimmed to provide a flat bottom surface (e.g., trimmed according to a plane defined by x-axis 120 and y-axis 122).

FIG. 5B shows an example of a sandal perimeter model 170 that supports methods for manufacturing custom orthotic sandals in accordance with examples described herein. The sandal perimeter model 170 may be determined according to a planar perimeter of the foot model 102. For example, a projection along a dimension (e.g., z-axis 124) of a perimeter of the foot model 102 may be obtained, and one or more functions may be applied to the perimeter to obtain the sandal perimeter model 170. For example, the perimeter may be scaled (e.g., expanded by an amount or a percentage). The perimeter may be scaled (e.g., expanded) by different amounts at different points around the perimeter. The scaled perimeter may be extruded to create sandal perimeter model 170. The midsole model 106 may be trimmed according to the sandal perimeter model 170. For example, portions of the midsole model 106 that extend past the sandal perimeter model 170 may be trimmed.

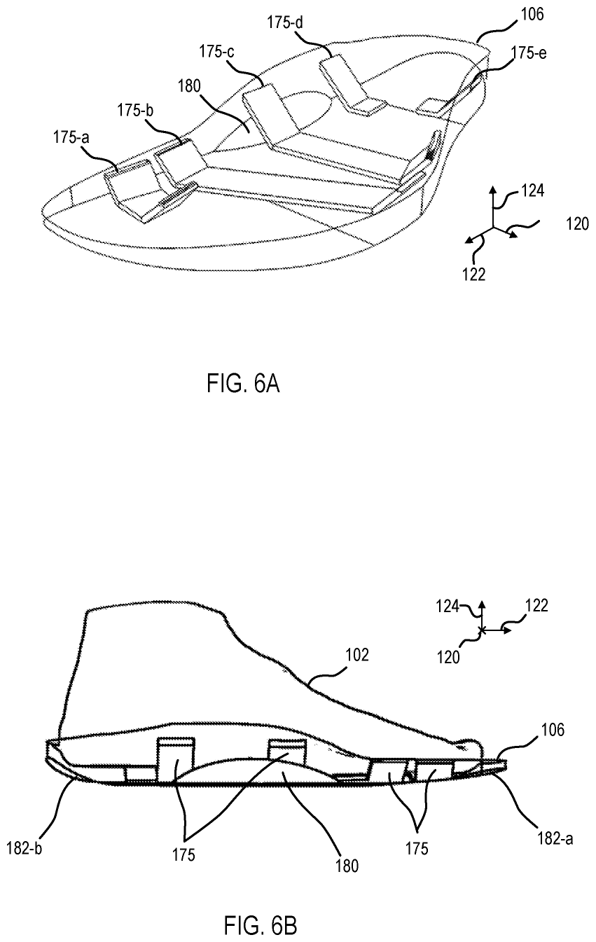

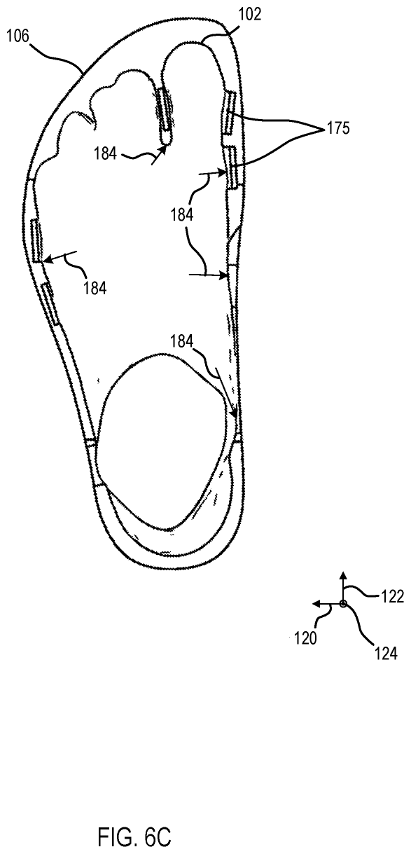

FIG. 6A shows an example of a midsole model 106 that supports methods for manufacturing custom orthotic sandals in accordance with examples described herein. The midsole model 106 shown in FIG. 6A includes channels 175, which may be subtracted from the midsole model. In the example shown in FIG. 6A, the midsole model 106 includes five channels (channel 175-a, channel 175-b, channel 175-c, channel 175-d, and channel 175-e). However, other numbers of channels 175 may be used. The channels 175 may be subtracted from the midsole model 106 for insertion of straps for the upper of the sandal.

FIGS. 6B and 6C show examples of a midsole model 106 that supports methods for manufacturing custom orthotic sandals in accordance with examples described herein. FIG. 6B shows the foot model 102 relative to the midsole model 106. The dimensions and placement of the channels 175 may be determined from one or more anatomical location points 184 of the foot model 102. For example, each of the anatomical location points 184 may be determined from one or more of the characteristics of the morphology of the foot model 102 described above such as length of the foot model 102, width of the foot model 102, location of an arch region of the foot model 102, the first point 161, the second point 162, the third point 163, the fourth point 164, or the fifth point 164 described above. In some cases, the anatomical location points 184 may be determined from additional characteristics of the morphology of the foot model 102 such as locations along the edge of the foot model 102.

FIG. 6B also illustrates areas trimmed from midsole model 106. For example, midsole model 106 may be trimmed according to an arch profile 180. Additionally or alternatively, midsole model 106 may be trimmed according to one or more rocker profiles 182. For example, a toe portion of the midsole model 106 may be trimmed according to rocker profile 182-a and a heel portion of the midsole model 106 may be trimmed according to rocker profile 182-b. Rocker profiles 182 may assist with balance, and redistribute plantar pressure during gait.

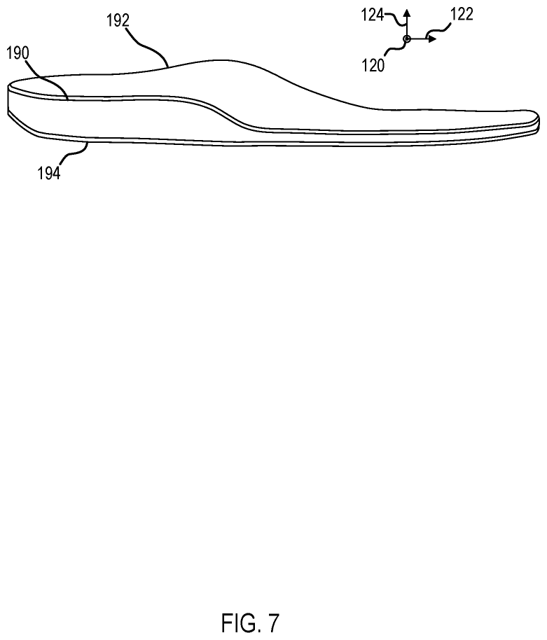

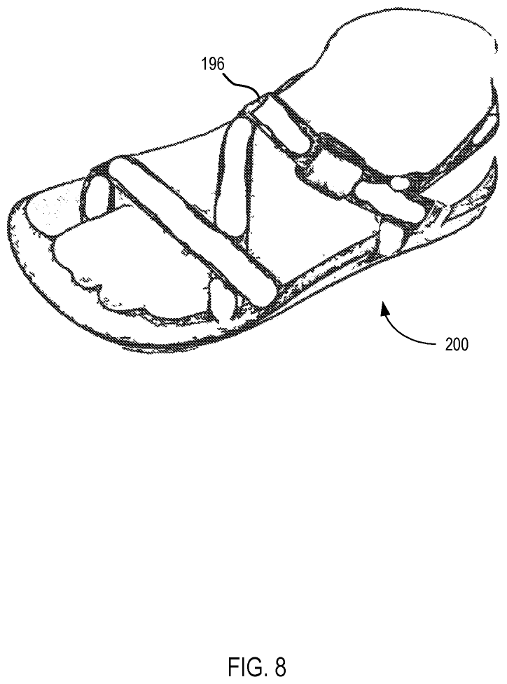

FIG. 7 shows an example of a sandal midsole 190 that supports methods for manufacturing custom orthotic sandals in accordance with examples described herein. The sandal midsole 190 may be manufactured out of one or more materials according to the midsole model 106 (e.g., midsole model 106 of FIGS. 6A-6C). For example, the sandal midsole 190 may be manufactured using an additive manufacturing process (e.g., 3D printing). In some cases, an infill pattern may be applied to the midsole model 106 prior to manufacturing the sandal midsole 190. For example, the infill pattern may be defined by a geometric pattern and a density. The geometric pattern may be, for example, a grid, triangle, pyramid, or honeycomb pattern. In some cases, different infill patterns may be used in different portions of the sandal midsole 190. Additionally or alternatively, different materials may be used in different portions of the sandal midsole. Using one or more infill patterns may allow the sandal midsole 190 to be lighter, and may affect other characteristics such as flex and compressibility for improved comfort or gait. In some cases, different materials and different infill patterns may be used in different portions of the sandal midsole 190. For example, an infill pattern of a first density may be used in the hindfoot region, an infill pattern of a second density may be used in the midfoot region, and an infill pattern of a third density may be used in the forefoot region. The hindfoot region, midfoot region, and forefoot region may be made out of the same material, or different materials. In some cases, the infill pattern in the forefoot region may be less dense to allow for increased flex of the sandal midsole during the wearer's gait.

After manufacturing the sandal midsole 190, a sole 194 may be adhered (e.g., glued) to the underside of the sandal midsole 190. The sole 194 may be, for example, made from a rubber material (e.g., Vibram sole). In some cases the sole 194 may be a sheet of rubber sole material larger than the sandal midsole 190 and may be trimmed according to the sandal midsole 190 before or after being adhered to the sandal midsole 190. In addition, a cushioning layer 192 may be adhered to the top side of the sandal midsole 190. The cushioning layer 192 may be, for example, an open-cell or closed-cell foam and may have a fabric layer on a top surface. The fabric layer may have an antimicrobial treatment. In some cases, the cushioning layer 192 may be memory foam.

FIG. 8 shows an example of a sandal 200 that supports methods for manufacturing custom orthotic sandals in accordance with examples described herein. Sandal 200 may include the sandal midsole 190, cushioning layer 192, and sole 194 illustrated in FIG. 7. Sandal 200 is illustrated with straps 196, which may be passed through the channels 175 to strap the sandal 200 to the wearer's foot.

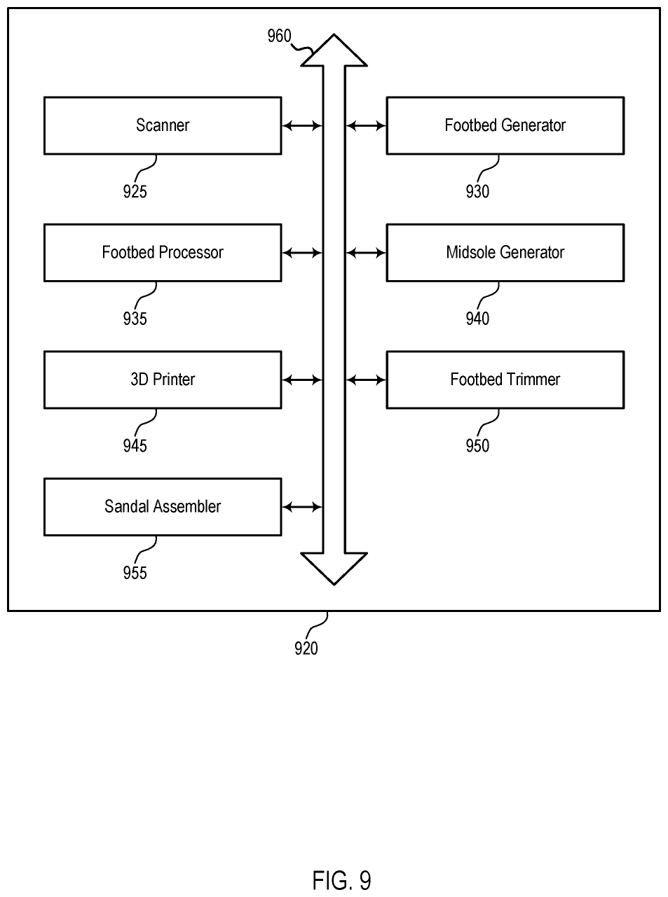

FIG. 9 illustrates an example of a system 920 that supports methods for manufacturing custom orthotic sandals in accordance with examples described herein. System 920 may include scanner 925, footbed generator 930, footbed processor 935, midsole generator 940, 3D printer 945, footbed trimmer 950, and sandal assembler 955. Each of these components may communicate, directly or indirectly, with one another (e.g., via one or more buses 960).

The scanner 925 may be configured as or otherwise support a means for scanning a foot of a subject to obtain a foot model (e.g., a representation of the foot). The scanner 925 may be, for example, a 3D scanner.

The footbed generator 930 may be configured as or otherwise support a means for generating a footbed model of the foot based at least in part on the foot model.

The footbed processor 935 may be configured as or otherwise support a means for applying one or more transforms to the footbed model. For example, applying the one or more transforms may include scaling at least a portion of the footbed model. Applying the one or more transforms may include expanding the footbed model along one or more bisection lines. At least one of the one or more bisection lines may intersect with a first point on a lateral edge of the footbed model and a second point on a front edge of the footbed model. The first point may correspond to a base of the fifth metatarsal of the foot and the second point may correspond to an interspace between a first toe and a second toe of the foot, the first toe being a biggest toe and the second toe being adjacent to the first toe. At least one of the one or more bisection lines may intersect with a third point on a medial edge of the footbed model and the second point. The third point may correspond to an apex of an arch of the foot. At least one of the one or more bisection lines may intersect with a fourth point on the medial side of the footbed model and a fifth point on the lateral side of the footbed model. For example, the at least one of the one or more bisection lines may bisect the footbed model along the metatarsophalangeal joints. At least one of the one or more bisection lines may bisect the footbed model along a frontal plane at a location associated with a weight bearing portion of a calcaneus of the foot. At least one of the one or more bisection lines may bisect the footbed model along central longitudinal plane. For the one or more of the bisection lines, an amount of expansion may vary along the one or more bisection lines.

The midsole generator 940 may be configured as or otherwise support a means for extruding the modified footbed model in at least one dimension. For example, the modified footbed model may extruded in a vertical direction, with trimming applied in a horizontal plane to obtain a midsole model having a volume (e.g., a 3D midsole model) and a flat bottom surface. The midsole generator 940 may apply one or more infill patterns to the midsole model. The midsole generator 940 may subtract one or more channels from the midsole model.

The 3D printer 945 may be configured as or otherwise support a means for manufacturing a sandal midsole out of a material according to the midsole model. The 3D printer may, for example, use one or more filament materials such as a polymer (e.g., Nylon, acrylonitrile butadiene styrene (ABS), polylactic acid (PLA), polyethylene terephthalate glycol (PETG)), thermoplastic (e.g., thermoplastic polyurethane (TPU)), or elastomer. The 3D printer 945 may use one or more materials for manufacturing the sandal midsole. For example, the 3D printer 945 may form a first portion of the midsole model using a first material and a second portion of the midsole model using a second material.

The footbed trimmer 950 may be configured as or otherwise support a means for trimming the midsole model according to a sandal perimeter model after extruding the midsole model.

The sandal assembler 955 may be configured as or otherwise support a means for adhering a sole to an underside the sandal midsole. The sandal assembler 955 may be configured as or otherwise support a means for adhering a cushioning layer to a top side of the sandal midsole. The sandal assembler 955 may be configured as or otherwise support a means for attaching one or more straps to the sandal midsole.

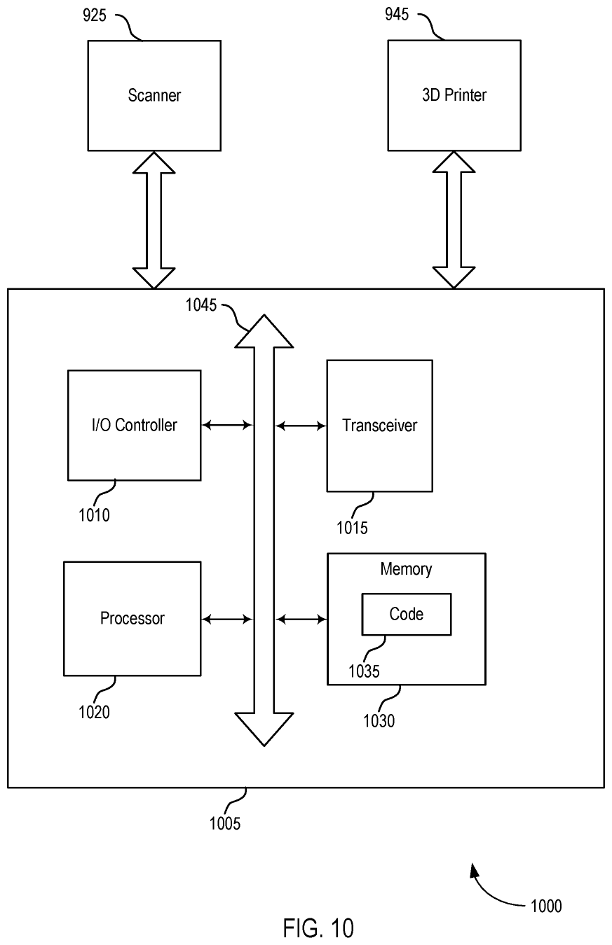

FIG. 10 illustrates an example of a system 1000 that supports methods for manufacturing custom orthotic sandal in accordance with examples described herein. System 1000 may include computing platform 1005, Scanner 925, and 3D printer 945. Computing platform 1005 may include I/O controller 1010, transceiver 1015, processor 1020, and memory 1030. These components may be in electronic communication via one or more buses (e.g., bus 1045).

The I/O controller 1010 may manage input signals and output signals for the computing platform 1005. The I/O controller 1010 may also manage peripherals not integrated into the computing platform 1005. In some cases, the I/O controller 1010 may represent a physical connection or port to an external peripheral. In some cases, the I/O controller 1010 may be implemented as part of processor 1020. In some cases, a user may interact with the computing platform via the I/O controller 1010 or via hardware components (e.g., input devices, output devices) controlled by the I/O controller 1010.

Memory 1030 may include various types of memory including volatile or non-volatile memory devices. The memory 1030 may store computer-readable, computer-executable software (e.g., code 1035) including instructions that, when executed, cause the processor 1020 to perform various functions described herein. In some cases, the memory 1030 may contain, among other things, a basic input/output system (BIOS) which may control basic hardware or software operation such as the interaction with peripheral components or devices.

The processor 1020 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1020 may be configured to operate a memory array using a memory controller. In other cases, a memory controller may be integrated into the processor 1020. The processor 1020 may be configured to execute computer-readable instructions stored in a memory 1030 to perform various functions.

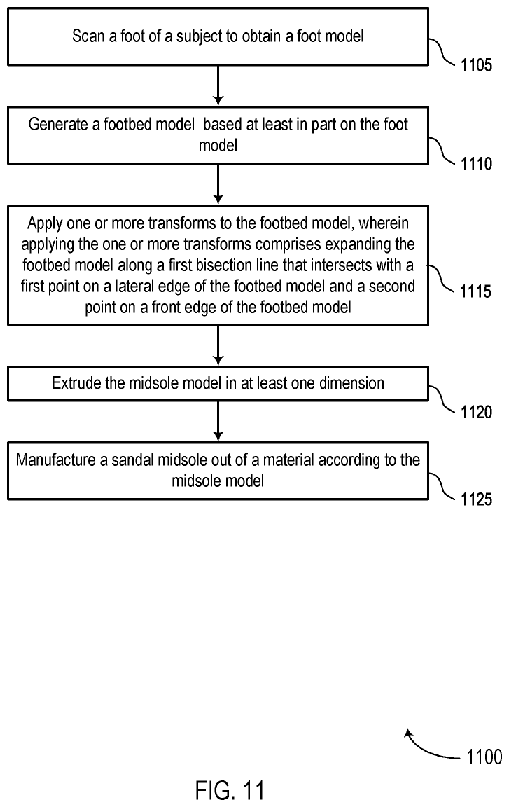

FIG. 11 illustrates an example of a method 1100 for manufacturing custom orthotic sandal in accordance with examples described herein. The operations of the method 1100 may be implemented by a system 920 or system 1000 or its components as described herein. In some examples, a processor 1020 may execute a set of instructions to control the functional elements of a computing platform 1005 to perform the described functions. Additionally, or alternatively, the computing platform 1005 may perform aspects of the described functions using special-purpose hardware.

The method 1100 may include scanning a foot of a subject to obtain a foot model at 1105. The scanning of the foot may be performed using a 3D scanner.

At 1110, the method 1100 may include generating a footbed model of the foot based at least in part on the foot model. The footbed model may be obtained by applying a section line to the foot model.

At 1115, the method 1100 may include applying one or more transforms to the footbed model. Applying the one or more transforms may include expanding the footbed model along one or more bisection lines. At least one of the one or more bisection lines may intersect with a first point on a lateral edge of the footbed model and a second point on a front edge of the footbed model. The first point may correspond to a base of the fifth metatarsal of the foot and the second point may correspond to an interspace between a first toe and a second toe of the foot, the first toe being a biggest toe and the second toe being adjacent to the first toe. At least one of the one or more bisection lines may intersect with a third point on a medial edge of the footbed model and the second point. The third point may correspond to an apex of an arch of the foot. At least one of the one or more bisection lines may intersect with a fourth point on the medial side of the footbed model and a fifth point on the lateral side of the footbed model. For example, the at least one of the one or more bisection lines may bisect the footbed model along the metatarsophalangeal joints. At least one of the one or more bisection lines may bisect the footbed model along a frontal plane at a location associated with a weight bearing portion of a calcaneus of the foot. At least one of the one or more bisection lines may bisect the footbed model along central longitudinal plane. At least one of the one or more bisection lines may extend from within a midfoot region of the footbed model to a toe region of the footbed model. At least one of the one or more bisection lines may cross a central longitudinal plane of the footbed model. In some cases, the one or more bisection lines include a first bisection line that intersects with a second bisection line. An amount of expansion may vary along at least one of the one or more bisection lines.

At 1120, the method 1100 may include extruding the modified footbed model in at least one dimension. For example, the modified footbed model may be extruded in a vertical direction and a section plane may be applied to provide a flat bottom surface.

At 1125, the method 1100 may include manufacturing a sandal midsole out of a material according to the midsole model. For example, the sandal midsole may be manufactured using an additive manufacturing process (e.g., 3D printing). In some cases, the method 1100 may include subtracting one or more channels from the midsole model prior to manufacturing the sandal midsole. In some cases, one or more straps may be inserted in the one or more channels of the sandal midsole. In some cases, an infill pattern may be applied to the midsole model prior to forming the sandal midsole. In some cases, manufacturing the sandal midsole comprises forming a first portion of the midsole model using a first material and a second portion of the midsole model using a second material. In some cases, the midsole model may be trimmed according to a rocker profile, an arch profile, or both, prior to manufacturing the sandal midsole.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read only memory (EEPROM), flash memory, compact disk read only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
scanning a foot of a subject to obtain a foot model;
generating a footbed model of the foot based at least in part on the foot model;
applying one or more transforms to the footbed model, wherein applying the one or more transforms comprises expanding the footbed model along a first bisection line that intersects with a first point on a lateral edge of the footbed model and a second point on a front edge of the footbed model;
extruding the footbed model in at least one dimension to obtain a midsole model; and
manufacturing a sandal midsole out of a material according to the midsole model.

2. The method of claim 1, wherein applying the one or more transforms comprises:
expanding the footbed model along a plurality of bisection lines, the plurality of bisection lines comprising the first bisection line.

3. The method of claim 2, wherein the plurality of bisection lines comprises a second bisection line that intersects with a third point on a medial edge of the footbed model and the second point.

4. The method of claim 3, wherein the third point corresponds to an apex of an arch of the foot.

5. The method of claim 2, wherein the plurality of bisection lines comprises a third bisection line that intersects with a fourth point on the medial side of the footbed model and a fifth point on the lateral side of the footbed model.

6. The method of claim 5, wherein the third bisection line bisects the footbed model along the metatarsophalangeal joints.

7. The method of claim 2, wherein the plurality of bisection lines comprises a fourth bisection line that bisects the footbed model along a frontal plane at a location associated with a weight bearing portion of a calcaneus of the foot.

8. The method of claim 2, wherein the plurality of bisection lines comprises a fifth bisection line that bisects the footbed model along central longitudinal plane.

9. The method of claim 2, wherein an amount of expansion varies along at least one of the plurality of bisection lines.

10. The method of claim 1, wherein the first point corresponds to a base of the fifth metatarsal of the foot and the second point corresponds to an interspace between a first toe and a second toe of the foot, the first toe being a biggest toe and the second toe being adjacent to the first toe.

11. The method of claim 1, further comprising:
trimming the midsole model according to a sandal perimeter model after extruding the midsole model.

12. The method of claim 11, further comprising:
generating the sandal perimeter model based at least in part on a planar perimeter of the foot model.

13. The method of claim 1, further comprising:
adhering a sole to an underside the sandal midsole; and
adhering a cushioning layer to a top side of the sandal midsole.

14. The method of claim 1, further comprising:
attaching one or more straps to the sandal midsole.

15. The method of claim 14, further comprising:
subtracting one or more channels from the midsole model prior to manufacturing the sandal midsole, wherein attaching the one or more straps comprises inserting the one or more straps in the one or more channels of the sandal midsole.

16. The method of claim 15, further comprising:
aligning the one or more channels on the midsole model to one or more anatomical location points of the foot model.

17. The method of claim 1, wherein manufacturing the sandal midsole comprises forming the sandal midsole based at least in part on an additive manufacturing process.

18. The method of claim 17, further comprising:
applying an infill pattern to the midsole model prior to forming the sandal midsole.

19. The method of claim 1, wherein manufacturing the sandal midsole comprises forming a first portion of the midsole model using a first material and a second portion of the midsole model using a second material.

20. The method of claim 1, further comprising:
trimming the midsole model according to at least one of a rocker profile or an arch profile prior to manufacturing the sandal midsole.
